(19) United States
(12) Patent Application Publication
(10) Pub. No.: US 2014/0013054 A1
(43) Pub. Date: Jan. 9, 2014

(54) STORING DATA STRUCTURES IN CACHE

(71) Applicants: Jichuan Chang, Sunnyvale, CA (US); Parthasarathy Ranganathan, San Jose, CA (US)

(72) Inventors: Jichuan Chang, Sunnyvale, CA (US); Parthasarathy Ranganathan, San Jose, CA (US)

(21) Appl. No.: 13/544,575

(22) Filed: Jul. 9, 2012

(51) Int. Cl. G06F 12/08

(52) U.S. Cl. 711/122; 711/E12.024

(57) ABSTRACT

A method and system for implementing a data structure cache are provided herein. The method includes identifying a data structure. The method also includes identifying a plurality of frequently accessed data blocks in the data structure. Additionally, the method includes reserving a portion of a cache for storage of the frequently accessed data blocks. Furthermore, the method includes storing the frequently accessed data blocks in the reserved portion of the cache.

### BACKGROUND

Software and hardware components of computing systems are constantly evolving in order to increase the computational power and efficiency of the computing systems. Accordingly, the memory devices of computing systems are continuously modified to increase the speed and efficiency in which a processor can access data residing in the memory devices. In order to facilitate quick data access, many computing systems have incorporated intermediate levels of memory, also known as caches, which are located between the processor and the storage device. Caches enable processors to search for data in a smaller memory device, which reduces latency. However, since the cache may store less data than the storage device, the processor may still retrieve data from the storage device in some instances, which is inefficient. In order to maintain efficiency in data retrieval, some modern computing systems use multi-level caches. The multi-level caches allow for several layers of different sized caches to funnel data from the storage device to the processor, thereby reducing latency.

### BRIEF DESCRIPTION OF THE DRAWINGS

The following detailed description may be better understood by referencing the accompanying drawings, which contain specific examples of numerous objects and features of the present techniques.

FIG. 1 is a block diagram of an example of a computing system that may be used for implementing a data structure cache.

FIG. 2 is a process flow diagram illustrating an example of a method for implementing a data structure cache.

FIG. 3 is an example which illustrates the contents of a data structure cache.

FIG. 4 is a process flow diagram illustrating an example of a method for requesting data from a data structure cache.

### DETAILED DESCRIPTION OF SPECIFIC EXAMPLES

Computing systems that include a multi-level cache can reduce latency, but the multi-level cache can still be inefficient. For example, each cache can store a data block in a cache line. The cache line can include a data block and can be indexed by the memory address of the data block. In this example, the size of the cache line is static. Therefore, each cache line has a size equal to a fixed number such as 32 bytes or 64 bytes. Accordingly, the data block stored in each cache line is also a fixed size, which can be inefficient.

In order to reduce the inefficiencies inherent with data storage in a cache, portions of data structures may be stored in a cache. A cache that can store portions of data structures, also referred to herein as a data structure cache, can store portions of any type of data structure, such as an array, linked list, hash table, vector, and the like. For example, a linked list may store data in 4-byte blocks of data. Therefore, a data structure cache can store eight separate, non-consecutive 4-byte blocks of data using 32 bytes. In contrast, a fixed-size 32-byte cache line may store 8 consecutive 4-byte blocks of data. Thus, incorporating a data structure cache can allow more efficient data storage and bandwidth consumption by allowing non-consecutive data blocks to be stored in the same cache line.

The data blocks stored in a data structure cache may represent elements, records, or subfields of data structures. Also, each of the data blocks may differ from the size of the fixed cache line. Additionally, each of the data blocks may have a different probability of being accessed. For example, a 32-byte cache line can store two consecutive 16-byte data blocks. However, one of the 16-byte data blocks may not be accessed. Furthermore, the second 16-byte data block may be frequently accessed and may store two 8-byte subfield data blocks, but only one of the 8-byte subfield data blocks may be accessed. Therefore, in this example, seventy-five percent of the cache line contains data that is not accessed.

In order to prevent a data structure cache from storing data blocks that are not accessed, data structure caches can be organized to include frequently accessed data blocks. The frequently accessed data blocks, as referred to herein, can include elements of data structures, subfields of data structures, or any other data blocks associated with data structures. The frequently accessed data blocks can be identified by various components of computing systems including applications, compilers, and hardware components.

The data structure cache can be created statically or dynamically. For example, the data structure cache may be of a fixed size and the data structure cache may be configured each time a computing system begins executing instructions. In this example, the data structure cache can store data blocks frequently accessed by any number of applications executed by the computing system. In other examples, the data structure cache is dynamically created each time an application begins executing instructions. Therefore, the data structure cache can also represent data blocks frequently accessed by a particular application. Furthermore, in some examples the application being executed is unaware of the data structure cache. In these examples, the implementation of a data structure cache is transparent to the applications.

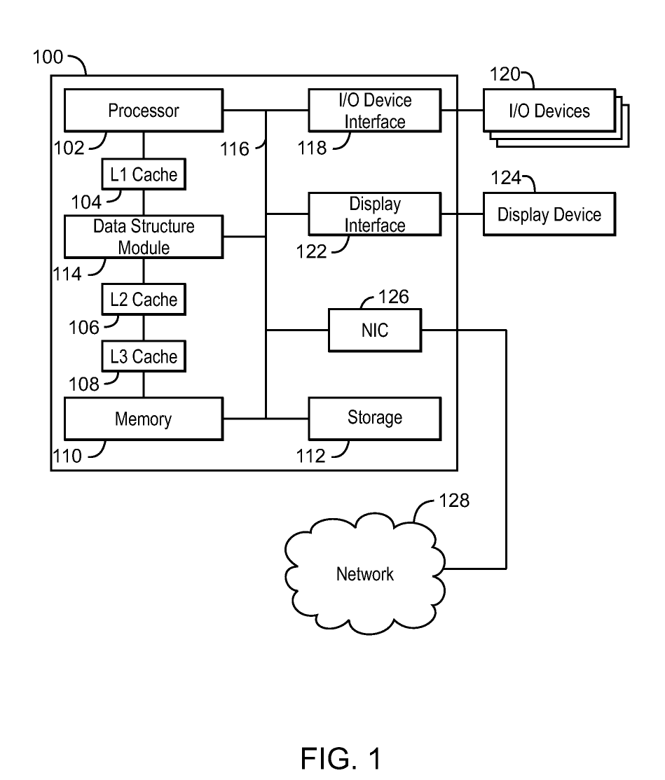

FIG. 1 is a block diagram of an example of a computing system 100 that may be used for implementing a data structure cache. The computing system 100 may be, for example, a mobile phone, laptop computer, desktop computer, or tablet computer, among others. The computing system 100 may include a processor 102 that is adapted to execute stored instructions. The processor 102 can be a single core processor, a multi-core processor, a computing cluster, or any number of other configurations. The processor 102 first searches for stored instructions and data in the L1 cache 104. In some examples, the L1 cache 104 can store less instructions and data than an L2 cache 106 or an L3 cache 108. The processor 102 searches for stored instructions and data in the L2 cache 106 whenever the L1 cache 104 does not contain the requested instructions or data. In some examples, the L2 cache 106 can store a larger number of stored instructions and data than the L1 cache 104. If the L2 cache 106 does not contain the requested instructions or data, the processor 102 searches for the requested instructions or data in the L3 cache 108. In some examples, the L3 cache 108 can store a larger number of stored instructions and data than either the L1 cache 104 or the L2 cache 106. If the L3 cache 108 does not contain the requested instructions or data, the processor 102 searches for the requested instructions or data in a memory 110. In some examples, the memory 110 can store a larger number of stored instructions and data than the L3 cache 108. The memory 110 can include random access memory (e.g., SRAM, DRAM, SONOS, eDRAM, EDO RAM, DDR RAM, RRAM, PRAM, among others), read only memory (e.g., Mask ROM, PROM, EPROM, EEPROM, among others), flash memory, non-volatile memory, or any other suitable memory systems. Finally, if the requested instructions or data are not located in memory 110, the processor 102 searches for the requested instructions or data in a storage device 112. The storage device 112 can include a hard drive, an optical drive, a USB flash drive, an array of drives, or any combinations thereof. In some examples, the storage device 112 can contain all of the stored instructions and data for the computing system 100.

The data structure module 114 may implement data structure caches using a portion of conventional L2 cache 106 or L3 cache 108. In other examples, the data structure module 114 may store instructions that implement a data structure cache in the L2 cache 106 or L3 cache 108. In these examples, the data structure module 114 can then send the instructions that implement a data structure cache in the L2 cache 106 or L3 cache 108 to the processor 102 for execution.

The processor 102 may be connected through a system bus 116 (e.g., PCI, PCI Express, HyperTransport®, Serial ATA, among others) to an input/output (I/O) device interface 118 adapted to connect the computing system 100 to one or more I/O devices 120. The I/O devices 120 may include, for example, a keyboard and a pointing device, wherein the pointing device may include a touchpad or a touchscreen, among others. The I/O devices 120 may be built-in components of the computing system 100, or may be devices that are externally connected to the computing system 100.

The processor 102 may also be linked through the system bus 116 to a display interface 122 adapted to connect the computing system 100 to a display device 124. The display device 124 may include a display screen that is a built-in component of the computing system 100. The display device 124 may also include a computer monitor, television, or projector, among others, that is externally connected to the computing system 100. Additionally, the processor 102 may also be linked through the system bus 116 to a network interface card (NIC) 126. The NIC 126 may be adapted to connect the computing system 100 through the system bus 116 to a network 128. The network 128 may be a wide area network (WAN), local area network (LAN), or the Internet, among others.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., additional levels of cache, video cards, additional network interfaces, etc.). Furthermore, any of the functionalities of the caches 104, 106, or 108 or the data structure module 114 may be partially, or entirely, implemented in hardware or in the processor 102. For example, the functionality may be implemented with an application specific integrated circuit, in logic implemented in the processor 102, in a co-processor on a peripheral device, or in a programmable state machine, among others. A programmable state machine, as referred to herein, includes any device that can execute executable code or store a status at a given time and can operate on input to change the status and/or cause an action or output to take place. Also, the components show in FIG. 1 may be interconnected in a variety of different configurations. For example, the data structure module 114 may reside between the L1 cache 104 and the L2 cache 106. Furthermore, in some examples the data structure module 114 may reside between the processor 102 and the L1 cache 104, or between the L2 cache 106 and L3 cache 108, or between any other memory devices.

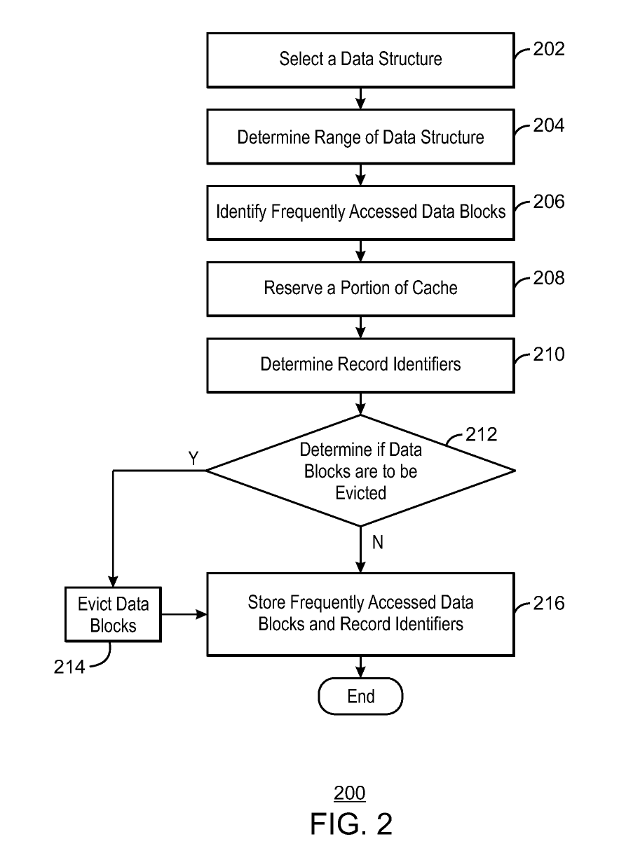

FIG. 2 is a process flow diagram illustrating an example of a method for implementing a data structure cache. The method 200 may be used to initialize a data structure cache and store data blocks in the data structure cache by using a computing system, such as the computing system 100 described in FIG. 1. The method 200 may be implemented by the data structure module 114, which can store portions of a data structure in a data structure cache.

At block 202, a data structure is selected to be stored in a data structure cache. As previously discussed, any type of data structure, such as vectors, arrays, or hash tables, among others, can include data structure elements that can be stored in a data structure cache. In some examples, the data structure module 114 may select portions of a data structure to be stored in a cache. For example, the data structure module 114 may determine that a data structure residing in memory includes frequently accessed data. The data structure module 114 may then determine the frequently accessed data of the data structure can be stored in a data structure cache. In other examples, an application or a compiler in a computing system can select the data structure to be stored in a data structure cache by monitoring the frequently accessed data blocks.

At block 204, the range of the data structure is determined. In some examples, the range of the data structure is calculated by determining the difference between the first memory address that stores data for the data structure and the last memory address that stores data for the data structure. The calculation of the range of the data structure can be performed by the data structure module 114, an application, or a compiler, among other components of a computing system.

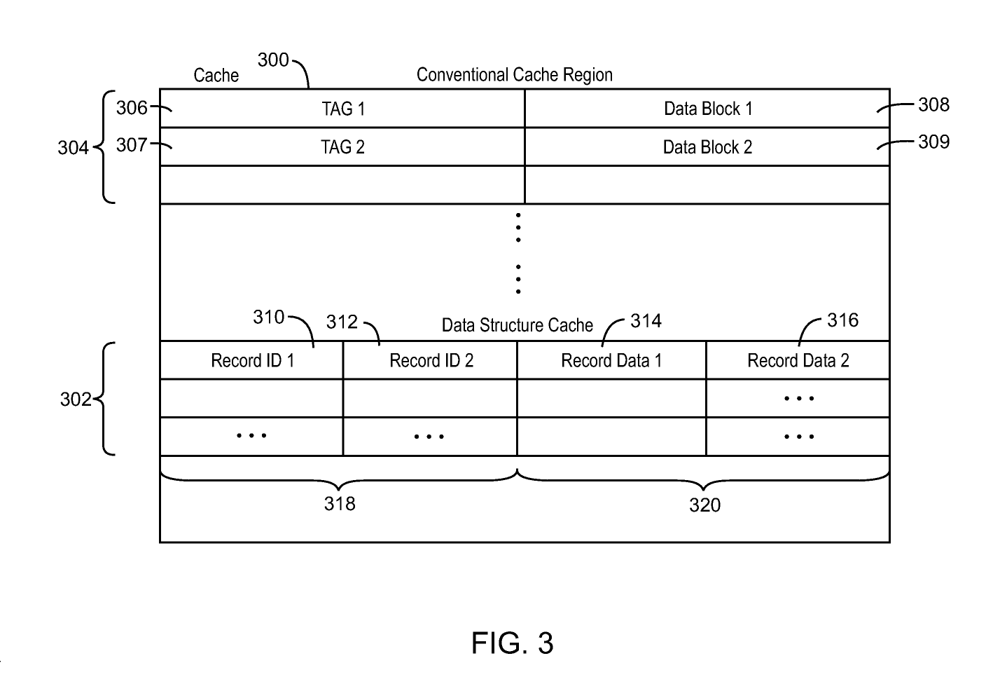

In other examples, the range of the data structure is determined by identifying a specific segment of memory that includes a data structure. In these examples, a segment identifier is stored in a segment register. The segment register may reside in an L2 cache, an L3 cache, a processor, or any other hardware component in a computing system. The segment identifier may indicate the segment of memory that stores the data structure. Additionally, the segment identifier can be used to determine if a requested data block resides in a data structure cache. For example, the data structure module 114 can translate the logical memory address of a requested data block into a virtual memory address that indicates different memory segments. If the requested virtual memory address is located in the memory segment identified by the segment register, the data structure cache can be searched for the requested data block. If the requested data block does not reside in the data structure, the data structure module 114 can then search for the requested data block in the conventional cache area or additional memory devices, such as the L3 cache. The conventional cache area is discussed in greater detail below in relation to FIG. 3.

At block 206 frequently accessed data blocks are identified. The frequently accessed data blocks may be identified by a compiler, by the data structure module 114, or by any other component of the computing system 100. For example, the data structure module 114 may monitor data blocks requested by the processor 102 from the L2 cache 106. The data structure module 114 can then determine which data blocks are most frequently accessed by the processor 102. As part of identifying the most frequently accessed data blocks, the data structure module 114 may also determine a common size of the frequently accessed data blocks. For example, the frequently accessed data blocks may all contain 8 bytes of data. Additionally, frequently accessed data blocks may be detected by monitoring the evicted or removed data blocks from L1 cache 104. Data blocks from the L1 cache 104 may be evicted whenever additional data blocks are stored in the L1 cache 104.

At block 208, a portion of cache is reserved for storing the frequently accessed data blocks. The portion of cache is an area that stores the frequently accessed data block. The portion of cache can be reserved within any range of the cache. For example, the frequently accessed data blocks may be stored within the first portion of the cache or the last portion of the cache. The portion of cache for storing the frequently accessed data blocks can also be reserved based on the set-associative properties of a cache. In some examples, the portion of cache may be substantially larger than the size of the remaining portion reserved for conventional caching. In other examples, the size of the portion of cache is identified based on frequently requested data blocks among other considerations. For example, 32 data blocks may be frequently accessed and each data block may include 4 bytes of data. Therefore, the size of the portion of cache in this example is at least 128 bytes.

At block 210, a record identifier is determined for each frequently accessed data block. A record identifier can be stored for each frequently accessed data block. The record identifier can be used as a tag to determine whether a frequently accessed data block matches the requested data block. In some examples, the record identifier is a unique identifier that is identified by the first memory address of the data structure, the frequently accessed data block memory address, and the data structure element size. For example, the record identifier can be calculated by determining the difference between the frequently accessed data block memory address and the first memory address of the data structure. The result of the difference can then be divided by the size of the data structure element to produce the record identifier.

At block 212, it is determined if data blocks are to be evicted from the portion of cache reserved for the data structure. If data blocks are not to be evicted, the process continues at block 216. If data blocks are to be evicted from the portion of cache reserved for the data structure, the process continues at block 214. Data blocks are evicted at block 214 by removing the data blocks from the portion of cache and placing the removed data blocks in other levels of cache or memory. For example, a data block evicted from L2 cache can be removed from the L2 cache and stored in L3 cache. In some examples, the data blocks are evicted from the portion of cache based on insertion policies for the data structure cache such as least recently used or first in first out, among others.

At block 216, the frequently accessed data blocks and record identifiers are stored in the data structure cache. The data structure module 114 can then locate each frequently accessed data block within the data structure cache based on the first memory address of the segment of the data structure cache and the record identifier. In some examples, the data structure module can also generate a record index that corresponds with each cache line in the data structure cache. The record index can be used to locate the frequently accessed data block within the data structure cache.

In some examples, logical memory addresses are stored within the data structure cache, which allows the data structure module 114 to locate the physical memory addresses of the frequently accessed data blocks stored within the data structure cache. In other examples, the physical memory address associated with each frequently accessed data block may be stored in the data structure cache, rather than a logical memory address. The data structure module 114 may include functionality that can translate a physical memory address to a logical memory address or can translate a logical memory address to a physical memory address. For example, the data structure module 114 may access a translation lookaside buffer, which maps logical memory addresses to physical memory addresses.

The process flow diagram of FIG. 2 is not intended to indicate that the steps of the method 200 are to be executed in any particular order, or that all of the steps of the method 200 are to be included in every case. For example, the method 200 may store frequently accessed data blocks in a data structure cache before storing a segment identifier in a segment register. Further, any number of additional steps may be included within the method 200, depending on the specific application.

FIG. 3 is an example which illustrates the contents of a data structure cache. Any portion of the cache 300 may be segmented to include a data structure cache 302. In some examples, the entire cache 300 may store a data structure cache 302. In other examples, the data structure cache 302 may be stored at the beginning and the end of the cache 300.

In this example, the cache is split between the conventional cache area 304 and the data structure cache 302. The conventional cache area 304 includes tags 306 and 307, and data blocks 308 and 309. As discussed above, one data block 308 is stored in each cache line. The tags 306 and 307 can include a portion of the memory address corresponding to the data blocks 308 and 309. A tag 306 corresponding to a data block 308 residing in the conventional cache area 304 can be compared to the tag of the requested data to determine if the requested data resides in the conventional cache area 304. If the two tags do not match, a processor may search additional levels of memory, such as an L3 cache or a memory device.

The data structure cache 302 includes record identifiers 310 and 312, and record data blocks 314 and 316. As previously discussed, the record identifiers 310 and 312, also referred to herein as record IDs, allow the data structure module 114 to determine if a requested data block resides in a data structure cache 302. For instance, the record identifier 310 may store a 16 bit number that is derived from the memory address of a particular record data block 314. The data structure module 114 can compare the record ID derived from the memory address of the requested data block to the record ID 310 to determine if the requested data block is stored in the data structure cache 302. In some examples, the record identifier 310 may be smaller than the tags 306 and 307 used in the conventional cache area 304. In these examples, multiple record identifiers 310 and 312 may be stored in one tag of a tag array 318. The number of records that can be stored in each conventional cache line can depend on the size of the data block 314 and 316 and the size of the cache line 320. In the example illustrated in FIG. 3, two non-consecutive 16-byte record data blocks 314 and 316 can be stored on the same 32-byte cache line 320.

The block diagram of FIG. 3 is for illustrative purposes only and can store data in any number of different configurations. Furthermore, any number of additional records can be stored within each cache line of the data structure cache 302 depending on the size of the records and the size of the cache line. For example, four 8-byte record data blocks may be stored on a single 32-byte cache line within the data structure 302.

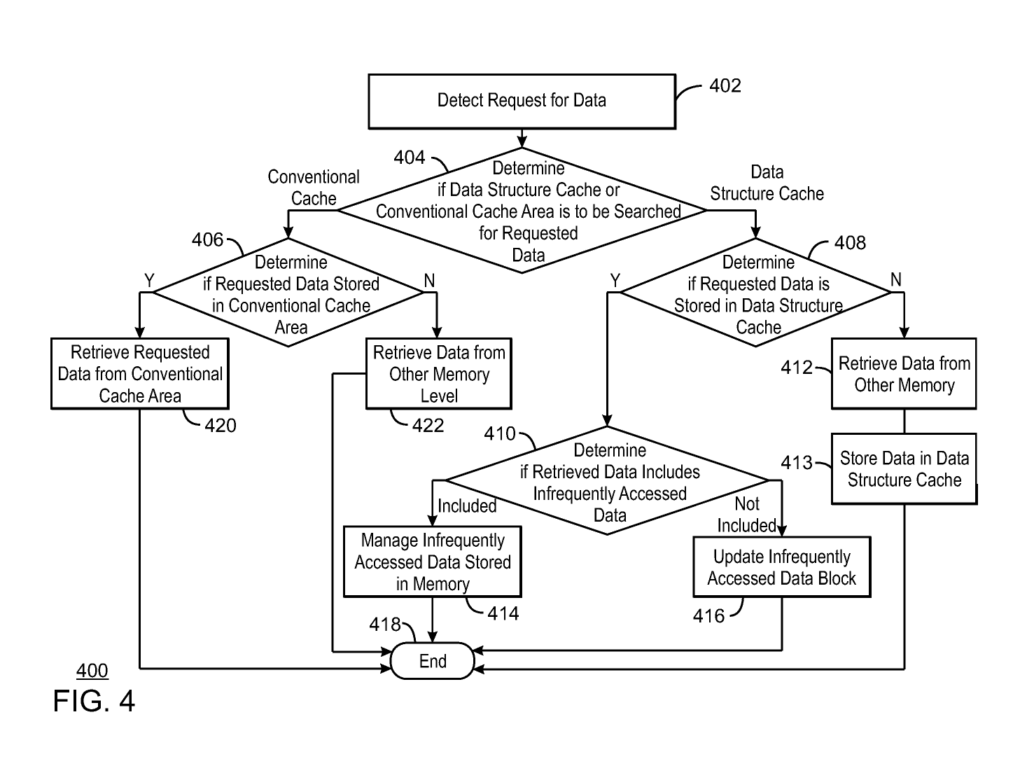

FIG. 4 is a process flow diagram illustrating an example of a method for requesting data from a data structure cache. The method 400 may be implemented in response to the processor 102 (FIG. 1) requesting stored instructions or data that reside in the L2 cache 106 or L3 cache 108, or in response to a cache coherence request coming from other processors or I/O modules. For example, the processor 102 may execute instructions that include or initiate requests for data. The processor 102 may then search the L1 cache 104 and the L2 cache 106, among other memory storage areas, for the requested data.

At block 402, a request for data is detected by the data structure module 114. The request for data originates with the processor, which first searches for the requested data in an L1 cache. If the processor 102 cannot find the requested data in the L1 cache, the processor next searches for the requested data in an L2 cache. However, the requested data may be stored in a data structure cache. In this example, the L1 cache sends the request for data first to the data structure module 114. The data structure module 114 can then search the data structure cache for requested data prior to searching for the requested data in the L2 cache or other levels of cache or memory. In some examples, instructions that implement a cache coherence request may also request data.

At block 404, it is determined if the data structure cache in L2 cache or the conventional cache area of the L2 cache is to be searched for the requested data. As discussed above in FIG. 2, the data structure module 114 can determine if the requested data is stored in the data structure cache by determining if the memory address of the requested data is within the range of the data structure segment of memory. Additionally, the data structure module 114 can determine if the requested data is stored in the data structure cache by comparing the memory address of the requested data to the segment identifier stored in the segment register. If the conventional cache area is to be searched for the requested data, the flow continues at block 406. If the data structure cache is to be searched for the requested data, the flow continues at block 408.

At block 408, it is determined if the requested data resides in the data structure cache. The record identifiers in the data structure cache are compared to the record identifier of the requested data. As discussed above in relation to FIG. 3, the record identifier is similar to the tag stored in the cache lines of the conventional cache area. The record identifier allows the data structure module 114 to compare the memory address of the requested data to the memory address of a record data block. The comparison of memory addresses allows the data structure module 114 to determine if a record data block is stored in the data structure cache. If the data structure cache does include a record data block containing the requested data, the process continues at block 410. If the data structure cache does not include a record data block containing the requested data, the process continues at block 412.

At block 410, it is determined if the requested data includes any infrequently accessed fields that are not stored in the data structure cache. For example, the data structure cache may include two out of three fields of a hash table. The two fields of the hash table stored in the data structure cache may include a key field and a value field. However, the data structure cache may not store the description field of the hash table because the description field is infrequently accessed. Therefore, if a processor requests a key field or value field from the data structure, the description field corresponding to the key field or value field will not be retrieved from the data structure cache. If it is determined that an infrequently accessed field is included in the requested data, the process continues at block 414. If it is determined the data structure module 114 has retrieved all of the requested data, the process continues at block 416.

At block 414, infrequently accessed data that corresponds to the retrieved data is identified and managed. As discussed in the example above, the description field of a hash table may be infrequently accessed and not stored in the data structure cache. Therefore, when the processor retrieves frequently accessed data from the data structure cache, the description field corresponding to the key field or value field may not be retrieved. In some examples, information is stored that indicates which elements or fields of a data structure are stored in a data structure cache. For example, a vector of “stored element bits” may indicate the elements or subfields of a data structure that are stored in the data structure cache. If infrequently accessed fields are requested, the data structure module 114 may retrieve the infrequently accessed data from another level of memory. The frequently accessed data block can then be concatenated with the infrequently accessed data block and sent to the data structure module 114 to satisfy the data request.

At block 416, infrequently accessed data is not requested. Accordingly, the data structure module 114 may send the retrieved frequently accessed data from the data structure cache to the processor without retrieving the corresponding infrequently accessed data from another level of memory (i.e. L3 cache, memory devices, storage, among others). The infrequently accessed data block information can then be updated. For example, stored element bits may be updated to reflect the current state of the infrequently accessed data blocks. In some examples, updating the current state of the infrequently accessed data blocks includes propagating the information to other levels of cache and memory. The process ends at block 418 after the infrequently accessed field is updated.

At block 412, the requested data is retrieved from another memory level after it is determined that the requested data does not reside in the data structure cache. The requested data may be stored in the L3 cache or memory, among other memory devices. In some examples, the processor may expect a data block of a certain size, which may be larger than the retrieved data block from the data structure. In these examples, the data structure module 114 may need to update stored element bits to indicate the data blocks stored in the cache. In other examples, the data structure module 114 can retrieve multiple data blocks from a conventional cache area and concatenate the multiple data blocks.

At block 413, the retrieved data from another memory level is stored in the data structure cache. As discussed in relation to FIG. 2, storing data in the data structure cache can include evicting infrequently accessed data from the data structure cache, calculating a record identifier for the retrieved data and storing the retrieved data and the record identifier in the data structure cache. In some examples, the retrieved data is inserted into the data structure cache based on a variety of insertion policies, such as least recently used or first in first out, among others. The process then ends at block 418.

If, at block 404, it is determined that the conventional cache is to be searched for the requested data, the flow continues at block 406. At block 406, it is determined if the requested data resides in the conventional cache area of the L2 cache. As discussed above in relation to FIG. 3, the tag corresponding with the data block in the conventional cache area is used to compare with the tag corresponding with the requested data block to determine if the requested data block resides in the conventional cache area. If the requested data resides in the conventional cache area, the process continues at block 420. If the requested data does not reside in the conventional cache area, the process continues at block 422.

At block 420, the requested data is retrieved from the conventional cache area. As discussed above in relation to FIG. 3, the requested data resides in data blocks stored in each cache line. Therefore, after identifying the data block in cache that has the same memory address as the requested data, the data block stored in cache is sent to the processor. The process ends at block 418.

At block 422, the requested data is retrieved from another level of memory. For example, the L3 cache may contain a larger number of data blocks than the L2 cache. Therefore, the processor may attempt to retrieve the requested data from L3 cache if the requested data is not stored in the L2 cache. In other examples, the processor may attempt to retrieve the requested data from memory if the requested data is not stored in the L3 cache. The requested data is retrieved and placed in the conventional cache area based on a conventional cache policy, such as least recently used or first in first out, among others. The process ends at block 418.

The process flow diagram of FIG. 4 is not intended to indicate that the steps of the method 400 are to be executed in any particular order, or that all of the steps of the method 400 are to be included in every case. Further, any number of additional steps may be included within the method 400, depending on the specific application. For example, the data structure module 114 can also search for two frequently accessed data blocks in parallel. If two frequently accessed data blocks are retrieved from the data structure cache, the two frequently accessed data blocks are concatenated and returned to the processor. If either of the frequently accessed data blocks is not retrieved from the data structure cache, other levels of memory can be searched for the frequently accessed data blocks that have not been retrieved.

The present examples may be susceptible to various modifications and alternative forms and have been shown only for illustrative purposes. For example, the present techniques support both reading and writing operations to a data structure cache. Furthermore, it is to be understood that the present techniques are not intended to be limited to the particular examples disclosed herein. Indeed, the scope of the appended claims is deemed to include all alternatives, modifications, and equivalents that are apparent to persons skilled in the art to which the disclosed subject matter pertains.

What is claimed is:

1. A method comprising:
identifying a data structure;
identifying a plurality of frequently accessed data blocks in the data structure;
reserving a portion of a cache for storage of the frequently accessed data blocks; and
storing the frequently accessed data blocks in the reserved portion of the cache.

2. The method of claim 1, comprising:
detecting a requested data block;
determining a cache segment identifier, wherein the cache segment identifier identifies the portion of the cache storing the plurality of frequently accessed data blocks; and
determining the requested data block is stored in the portion of the cache for storage of the frequently accessed data blocks based on the cache segment identifier.

3. The method of claim 1 further comprising generating a stored element bit vector, wherein the stored element bit vector indicates a plurality of elements and a plurality of subfields of the data structure that are stored in the portion of the cache for storage of the frequently accessed data blocks.

4. The method of claim 1 comprising:
calculating a record identifier for each of the frequently accessed data blocks; and
storing the record identifier in a tag array.

5. The method of claim 1 comprising:
detecting a request for a data block;
determining the data block is a frequently accessed data block;
determining the data block is stored in the reserved portion of the cache; and
retrieving the data block from the reserved portion of the cache.

6. The method of claim 5, comprising:
determining that an infrequently accessed data block corresponds to the data block;
retrieving the infrequently accessed data block from a second cache or memory; and
concatenating the data block and the infrequently accessed data block.

7. The method of claim 1, comprising:
detecting a plurality of requests for a plurality of data blocks;
determining the data blocks reside in the portion of the cache for storage of the frequently accessed data blocks; and
concatenating the plurality of data blocks.

8. The method of claim 1, wherein storing the plurality of frequently accessed data blocks in the portion of the cache further comprises calculating a record index for each of the frequently accessed data blocks based on a plurality of memory addresses for the frequently accessed data blocks.

9. A system comprising:
a processor to execute stored instructions;
an L1 cache to store instructions;
an L2 cache to store instructions; and
a data structure module comprising processor executable code that, when executed by the processor, causes the processor to:
identify a data structure;
identify a plurality of frequently accessed data blocks in the data structure;
reserve a portion of a cache for storage of the frequently accessed data blocks;
determine a record identifier for each of the frequently accessed data blocks;
evict data blocks from the portion of the cache for storage of the frequently accessed data blocks;
store the record identifiers in the portion of the cache for storage of the frequently accessed data blocks; and
store the plurality of frequently accessed data blocks in the portion of the cache for storage of the frequently accessed data blocks.

10. The system of claim 9, wherein the processor executable code causes the processor to store a segment identifier in a register.

11. The system of claim 10, wherein the processor executable code causes the processor to translate a plurality of virtual addresses of the frequently accessed data blocks to a plurality of logical addresses.

12. The system of claim 10, wherein the processor executable code causes the processor to calculate a record index based on the memory address of each frequently accessed data block.

13. The system of claim 9, wherein the processor executable code causes the processor to:
create a record identifier for each frequently accessed data block; and
store the record identifier in a tag array.

14. The system of claim 9, wherein the processor executable code causes the processor to generate a stored element bit vector, wherein the stored element bit vector indicates a plurality of elements and a plurality of subfields of the data structure that are stored in the portion of the cache for storage of the frequently accessed data blocks.

15. The system of claim 9, wherein the processor executable code causes the processor to:
detect a plurality of requests for a plurality of data blocks;
determine the data blocks reside in the reserved portion of the cache; and
concatenate the plurality of data blocks.

16. A system comprising:
a processor;
an L1 cache to store instructions;
an L2 cache to store instructions; and
a data structure module comprising a programmable state machine that causes the processor to:
detect a request for a data block;
determine the data block is a frequently accessed data block;
determine the data block is stored in a data structure cache; and
retrieve the data block from the data structure cache.

17. The system of claim 16, wherein the programmable state machine causes the processor to:
determine that an infrequently accessed data block corresponds to the data block;
retrieve the infrequently accessed data block from memory; and
concatenate the data block and the infrequently accessed data block.

18. The system of claim 16, wherein the data structure module resides between a processor and a first cache.

19. The system of claim 16, wherein the data structure module resides between a first cache and a second cache.

20. The system of claim 16, wherein the programmable state machine causes the processor to:
detect a plurality of requests for a plurality of data blocks;
determine the plurality of data blocks reside in the data structure cache; and
concatenate the plurality of data blocks.
